(19) United States
(12) Patent Application Publication
(10) Pub. No.: US 2017/0196775 A1
(43) Pub. Date: Jul. 13, 2017

(54) NOVEL DELIVERY DEVICES AND METHODS

(71) Applicant: Jeremy Nelson, San Diego, CA (US)

(72) Inventor: Jeremy Nelson, San Diego, CA (US)

(21) Appl. No.: 15/316,756

(22) PCT Filed: Jun. 11, 2015
(86) PCT No.: PCT/US2015/035322

§ 371 Date: Dec. 6, 2016

Related U.S. Application Data
(60) Provisional application No. 62/010,476, filed on Jun. 11, 2014.

(51) Int. Cl. A61J 11/00; A61J 7/00

(52) U.S. Cl. CPC A61J 11/0075; A61J 7/0015

(57) ABSTRACT

Generally provided herein is a device for the delivery of liquids. In particular, a delivery device that attaches to a nipple and increases the accuracy and comfort when delivering medication to an infant/child.

### CROSS-REFERENCE TO RELATED APPLICATIONS

This application claims priority to U.S. Provisional Patent Application No. 62/010,476, filed Jun. 11, 2015, which is hereby incorporated by reference in its entirety.

### FIELD OF THE INVENTION

The present invention relates generally to delivery of liquids, and is particularly concerned with a delivery device that attaches to a nipple and increases the accuracy and comfort when delivering medication to an infant/child.

### SUMMARY OF THE INVENTION

Provided herein is a delivery device comprising a top surface, a bottom surface, a connector that attaches a funnel-like hole to the inside of the device and at least two threads attached to the outside walls of the device. In various embodiments, the outside walls of the device comprise from two to six threads. In specific embodiments, the outside walls of the device comprise two threads. In some embodiments, the outside walls of the device comprise three threads or four threads. In other embodiments, the outside walls of the device comprise five threads or six threads.

Also provided herein is a method for delivering a liquid to a subject comprising (1) attaching a device comprising a top surface, a bottom surface, a connector that attaches a funnel-like hole to the inside of the device and at least two threads attached to the outside walls of the device to a nipple, (2) adding the liquid to the device and (3) administering the liquid to the subject through the nipple.

In some embodiments of this method, the liquid is added to the device through the funnel. In other embodiments of this method, the liquid is added to the device after the device is attached to the nipple. In yet other embodiments of this method, the liquid is added to the device after the device is attached to the nipple.

Additional details of embodiments of the invention are set forth in the accompanying drawings and the description below. Other features, objects, and advantages of the embodiments will be apparent from the drawings and detailed description, and from the claims.

### BRIEF DESCRIPTION OF THE FIGURES

The details of the present disclosure, both as to its structure and operation, may be gleaned in part by study of the accompanying drawings, in which like reference numerals refer to like parts, and in which:

FIG. 1 exemplifies the bottom dimensions of the delivery device [100], according to one embodiment of the disclosure.

FIG. 2 exemplifies a bottom isometric view of the delivery device [100], according to one embodiment of the disclosure.

FIG. 3 exemplifies a bottom view of the delivery device [100], according to some embodiments of the disclosure.

FIG. 4 illustrates the cross section dimensions of the delivery device [100], according to one embodiment of the disclosure.

FIG. 5 provides a front view of the delivery device [100], according to one embodiment of the disclosure.

FIG. 6 exemplifies a top isometric view of the delivery device [100], according to one embodiment of the disclosure.

FIG. 7 provides a wire view of the delivery device [100], according to one embodiment of the disclosure.

FIG. 8 exemplifies the bottom dimensions of the delivery device [100], according to one embodiment of the disclosure.

FIG. 9 illustrates the cross section dimensions of the delivery device [100], according to one embodiment of the disclosure.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

### DESCRIPTION OF THE INVENTION

After reading this description it will become apparent to one skilled in the art how to implement the invention in various alternative embodiments and alternative applications. However, although various embodiments of the present invention will be described herein, it is understood that these embodiments are presented by way of example only, and not limitation.

Certain embodiments as disclosed herein provide for a delivery system, apparatus and method.

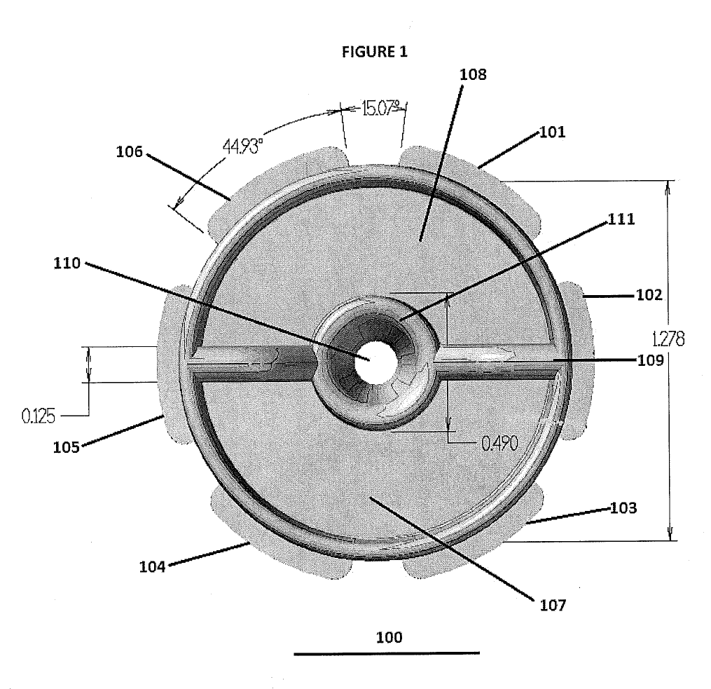

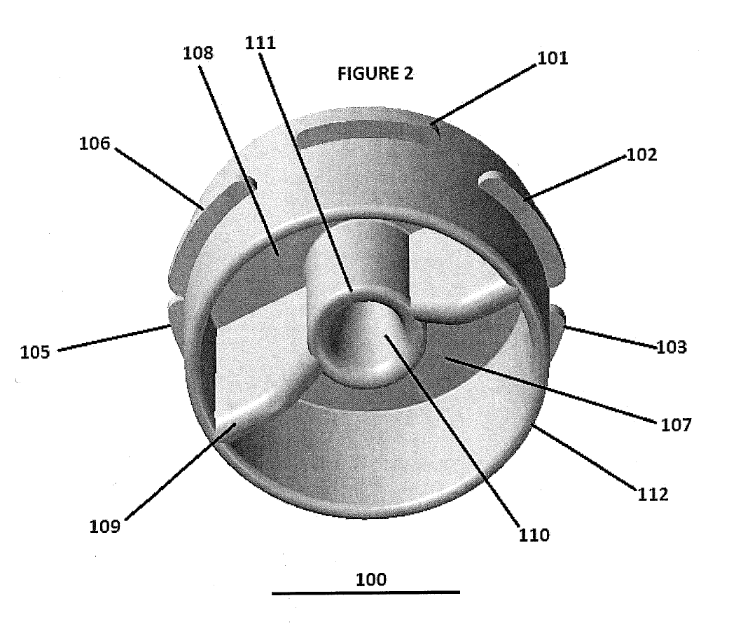

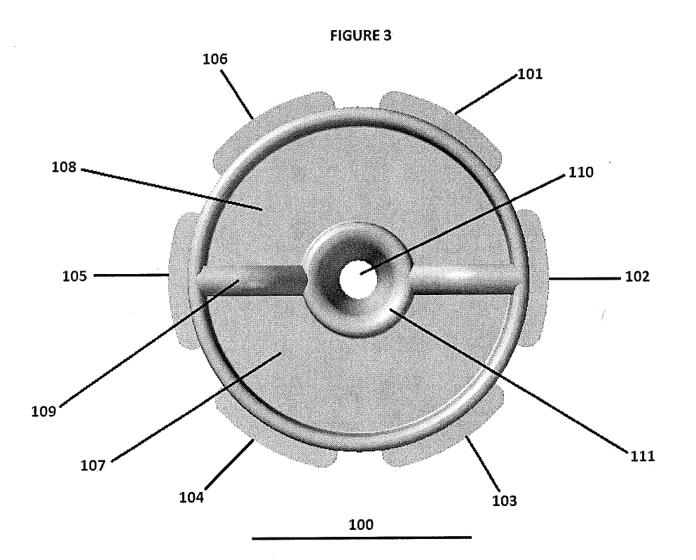

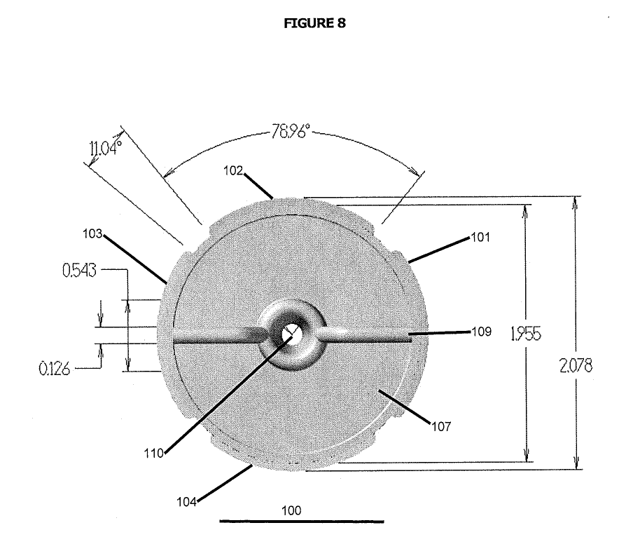

FIG. 1, FIG. 2, FIG. 3 and FIG. 8 each illustrate one embodiment of a delivery device 100 from a bottom view. The device basically comprises a top surface 113 (not shown) capable of separating a liquid from a nipple and a funnel-like whole in between the top surface 113 and the bottom of the device 107. In this embodiment, the funnel is attached to the walls of the device via a connector 109.

In various embodiments, the width of the funnel-like whole on the device expands a range of between about 0.01 cm to about 6 cm. In other embodiments, the width of the funnel-like whole expands a range between 0.02 cm to 5 cm, or between 0.05 cm to 5 cm, or between 1 cm to 5 cm, or between 1.5 cm to 5 cm, or between 1 cm to 4 cm, or between 1.5 cm to 4 cm, or between 1 cm to 3 cm, or between 1.5 cm to 3 cm, or between 1 cm to 2 cm, or between 1.5 cm to 2 cm.

The device 100 further comprises threads 101, 102, 103, 104, 105, 106 to secure the device 100 to a nipple. In various embodiments, the device comprises between two (2) to eight (8) threads. In some embodiments the device comprises three (3) threads. In other embodiments, the device comprises four (4) threads. In still other embodiments, the device comprises five (5) threads. In specific embodiments, the device comprises six (6) threads.

In various embodiments, the distance between the threads on the device is between about 0.01 cm to about 5 cm. In other embodiments, the distance between the threads on the device is between 0.05 cm to 5 cm, or between about 1 cm to about 5 cm, or between about 1 cm to about 4 cm, or between about 1 cm to about 3 cm, or between about 1 cm to about 2 cm. In some embodiments, the distance between the threads on the device is about 0.5 cm, or about 1 cm, or about 1.5 cm, or about 2 cm, or about 2.5 cm, or about 3 cm, or about 3.5 cm, or about 4 cm, or about 4.5 cm or about 5 cm.

In various embodiments, the device 100 has a height of between about 2 cm to about 12 cm. In some embodiments, the height is between 3 cm to 12 cm, or 4 cm to 12 cm, or 3 cm to 11 cm, or 5 cm to 12 cm, or 3 cm to 10 cm, or 6 cm to 12 cm, or 3 cm to 9 cm, or 7 cm to 12 cm, or 3 cm to 8 cm, or 8 cm to 12 cm, or 3 cm to 7 cm, or 9 cm to 12 cm, or 3 cm to 6 cm, or 10 cm to 12 cm, or 3 cm to 8 cm, or 11 cm to 12 cm, or 3 cm to 4 cm. In various embodiments, the height is 2 cm, or 2.5 cm, or 3 cm, or 3.5 cm, or 4 cm, or 4.5 cm, or 5 cm, or 5.5 cm, or 6 cm, or 6.5 cm, or 7 cm, or 7.5 cm, or 8 cm, or 8.5 cm, or 9 cm, or 9.5 cm, or 10 cm, or 10.5 cm, or 11 cm, or 11.5 cm, or 12 cm.

In various embodiments, the device 100 has a width of between about 2 cm to about 12 cm. In some embodiments, the width is between 3 cm to 12 cm, or 4 cm to 12 cm, or 3 cm to 11 cm, or 5 cm to 12 cm, or 3 cm to 10 cm, or 6 cm to 12 cm, or 3 cm to 9 cm, or 7 cm to 12 cm, or 3 cm to 8 cm, or 8 cm to 12 cm, or 3 cm to 7 cm, or 9 cm to 12 cm, or 3 cm to 6 cm, or 10 cm to 12 cm, or 3 cm to 8 cm, or 11 cm to 12 cm, or 3 cm to 4 cm. In various embodiments, the width is 2 cm, or 2.5 cm, or 3 cm, or 3.5 cm, or 4 cm, or 4.5 cm, or 5 cm, or 5.5 cm, or 6 cm, or 6.5 cm, or 7 cm, or 7.5 cm, or 8 cm, or 8.5 cm, or 9 cm, or 9.5 cm, or 10 cm, or 10.5 cm, or 11 cm, or 11.5 cm, or 12 cm.

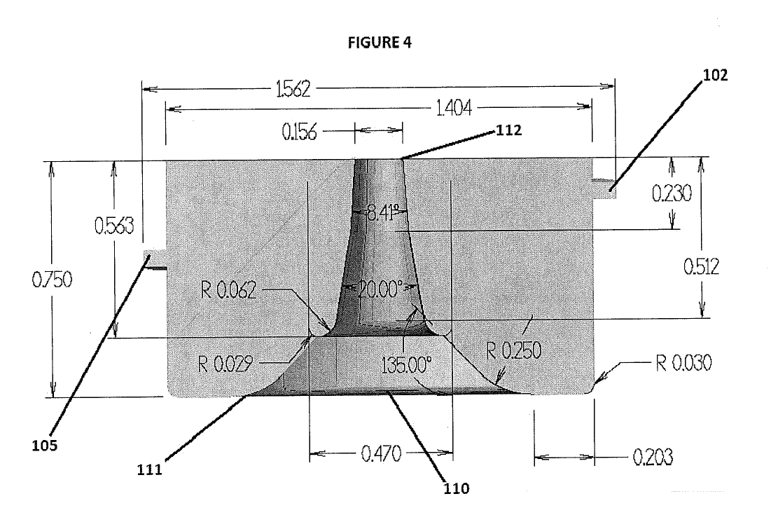

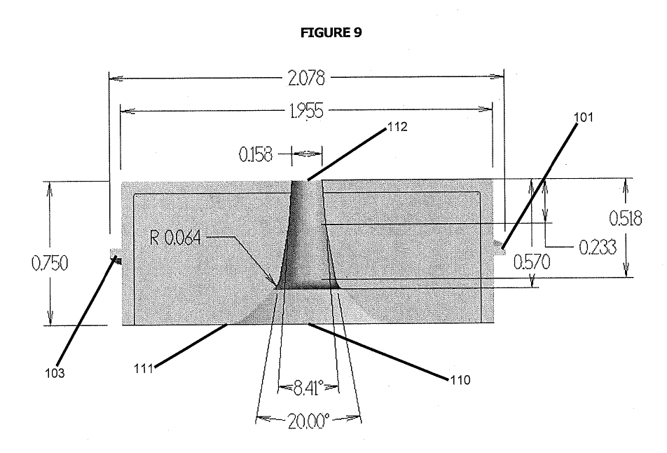

FIG. 4 and FIG. 9 provide each provide the dimensions for one embodiment of the funnel-like portion 110, 111, 112 of the device 100. These figures also provide specifications for the distance between two of the threads 102 and 105, and the top surface 113 (not shown) and the bottom of the device 107 (not shown) according to one embodiment of the invention. As one of skill in the art will understand, the distance between the threads and the top/bottom of the device will vary depending on the size of the device, the number of threads on the device and the width of the material used to make the device.

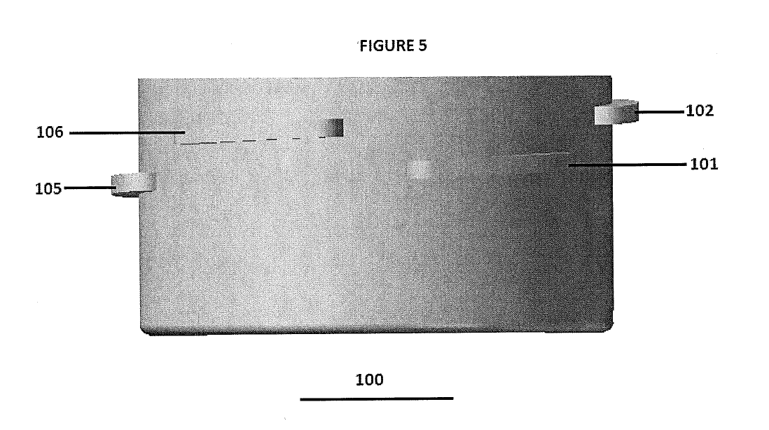

FIG. 5 illustrates a front view of one embodiment of the device 100.

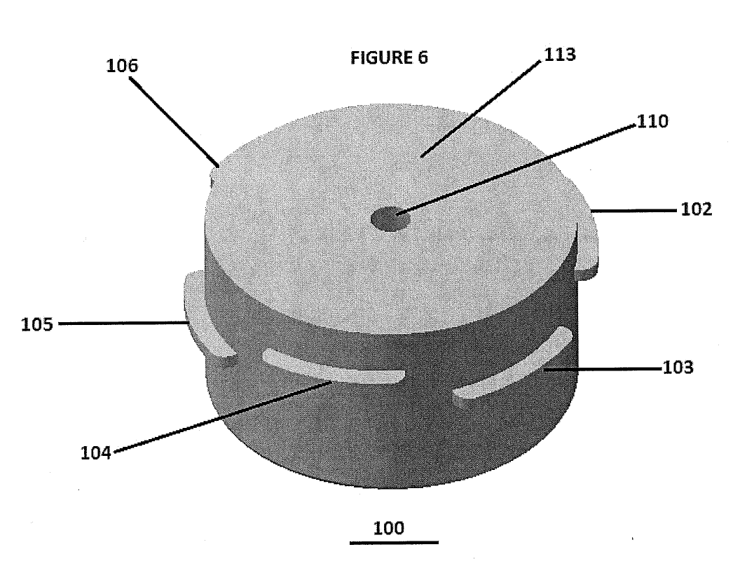

FIG. 6 illustrates an isometric view of one embodiment of the device 100.

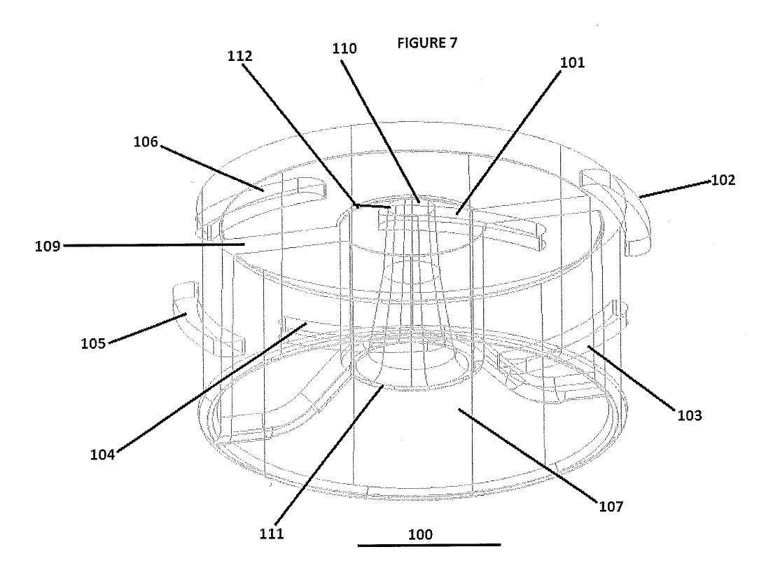

FIG. 7 illustrates a wire view of one embodiment of the device 100.

The above description of the disclosed embodiments to enable any person skilled in the art to make or use the invention. Various modifications to these embodiments will be readily apparent to those skilled in the art, and the generic principles described herein can be applied to other embodiments without departing from the spirit or scope of the disclosure. Thus, it is to be understood that the description and drawings presented herein represent an exemplary embodiment of the disclosure and are therefore representative of the subject matter which is broadly contemplated by the present invention. It is further understood that the scope of the present disclosure fully encompasses other embodiments that may become obvious to those skilled in the art and that the scope of the present disclosure is accordingly limited by nothing other than the appended claims.

1. A delivery device comprising a top surface, a bottom surface, a connector that attaches a funnel-like hole to the inside of the device and at least two threads attached to the outside walls of the device.

2. The delivery device of claim 1, wherein the outside walls of the device comprise from two to six threads.

3. The delivery device of claim 1, wherein the outside walls of the device comprise two threads.

4. The delivery device of claim 1, wherein the outside walls of the device comprise three threads.

5. The delivery device of Claim 1, wherein the outside walls of the device comprise four threads.

6. The delivery device of claim 1, wherein the outside walls of the device comprise five threads.

7. The delivery device of claim 1, wherein the outside walls of the device comprise six threads.

8. The delivery device of claim 1, wherein the height of the device is between about 2 cm to about 12 cm.

9. The delivery device of claim 8, wherein the width of the device is between about 2 cm to about 12 cm.

10. The delivery device of claim 1, wherein the width of the funnel expands about 0.1 cm to about 5 cm.

11. The delivery device of claim 10, wherein the distance between the threads is about 0.1 cm to about 5 cm.

12. A method for delivering a liquid to a subject comprising attaching a device according to any of the previous embodiments to a nipple, adding the liquid to the device and administering the liquid to the subject through the nipple.

13. The method of claim 12, wherein the liquid is added to the device through the funnel.

14. The method of claim 12, wherein the liquid is added to the device after the device is attached to the nipple.
